(19) United States
(12) Patent Application Publication
(10) Pub. No.: US 2026/0007962 A1
(43) Pub. Date: Jan. 8, 2026

(54) PROGRAM, CLIENT TERMINAL, GAME SYSTEM, AND PROCESSING METHOD

(71) Applicant: CYGAMES, INC., Tokyo (JP)

(72) Inventor: Shuichi Kurabayashi, Tokyo (JP)

(73) Assignee: CYGAMES, INC., Tokyo (JP)

(21) Appl. No.: 19/323,623

(22) Filed: Sep. 9, 2025

Related U.S. Application Data
(63) Continuation of application No. PCT/JP2024/011265, filed on Mar. 22, 2024.

(30) Foreign Application Priority Data
Mar. 29, 2023 (JP) 2023-052653

(51) Int. Cl. A63F 13/355; A63F 13/48

(52) U.S. Cl. CPC A63F 13/355; A63F 13/48

(57) ABSTRACT

A client terminal may include an estimation model for interpolating a missing streaming image. The estimation model may estimate an optical flow and depth information from streaming images I(0) to I(t) displayed before a missing streaming image I(t+1) and generate a streaming image I′(t+1) on the basis of the estimation result. The client terminal may display the generated streaming image I′(t+1) instead of the missing streaming image I(t+1).

### TECHNICAL FIELD

The present invention relates to a program, a client terminal, a processing method for the client terminal, a game system, and a processing method for the game system.

### BACKGROUND ART

A technology related to cloud gaming is disclosed in Patent Literature 1. In cloud gaming, a game program is executed on a server in the cloud. Specifically, a client terminal sends, to the server, an input event based on a user input. The server progresses the game by executing the game program on the basis of the input event, generates a game image after the game progress, and then sends the image to the client terminal by streaming. The client terminal displays the received image on a display or the like. With the recent improved GPU (Graphics Processing Unit) parallel performance, advanced GPU virtualization technology, and the advent of wideband networks represented by 5G, cloud gaming has attracted attention.

### CITATION LIST

### Patent Literature

[Patent Literature 1] Japanese Unexamined Patent Application, Publication No. 2023

### SUMMARY OF INVENTION

### Technical Problem

In streaming adopted in cloud gaming, there is a problem that images of several frames become missing due to network latency etc. This problem is a major obstacle to maintaining a natural game screen. A conventional technology for this problem is to send images speculatively rendered in a server to a client terminal in advance, which increases the loads on the network and the server. Patent Literature 1 does not disclose a means for solving this problem.

An object of the present invention is to solve a problem that a natural screen cannot be maintained when several frames are missing in image streaming.

### Solution to Problem

According to one aspect, the present invention provides a program causing a computer in a client terminal to function as:
an acceptance unit that accepts a user input related to the progress of a running game;
a transmission unit that transmits, to a server, input information indicating the content of the user input;
a reception unit that receives, from the server, a streaming image indicating the result of the progress of the running game executed at the server in response to the input information;
a detection unit that detects an event in which the streaming image is missing;
a generation unit that estimates, from a plurality of streaming images related to the running game, the content of a streaming image to be displayed after the plurality of streaming images and that generates an interpolated streaming image indicating the result of the estimation of the content of the missing streaming image on the basis of an estimation model for generating a streaming image indicating the estimated content and the plurality of streaming images displayed before the missing streaming image; and
a display control unit that displays the streaming image on a display device and that displays, instead of the missing streaming image, the interpolated streaming image on the display device.

Furthermore, according to another aspect, the present invention provides a client terminal including:
an acceptance unit that accepts a user input related to the progress of a running game;
a transmission unit that transmits, to a server, input information indicating the content of the user input;
a reception unit that receives, from the server, a streaming image indicating the result of the progress of the running game executed at the server in response to the input information;
a detection unit that detects an event in which the streaming image is missing;
a generation unit that estimates, from a plurality of streaming images related to the running game, the content of a streaming image to be displayed after the plurality of streaming images and that generates an interpolated streaming image indicating the result of the estimation of the content of the missing streaming image on the basis of an estimation model for generating a streaming image indicating the estimated content and the plurality of streaming images displayed before the missing streaming image; and
a display control unit that displays the streaming image on a display device and that displays, instead of the missing streaming image, the interpolated streaming image on the display device.

Furthermore, according to still another aspect, the present invention provides a processing method including:
in a client terminal,
   accepting a user input related to the progress of a running game;
   transmitting, to a server, input information indicating the content of the user input;
   receiving, from the server, a streaming image indicating the result of the progress of the running game executed at the server in response to the input information;
   detecting an event in which the streaming image is missing;
   estimating, from a plurality of streaming images related to the running game, the content of a streaming image to be displayed after the plurality of streaming images, and generating an interpolated streaming image indicating the result of the estimation of the content of the missing streaming image on the basis of an estimation model for generating a streaming image indicating the estimated content and the plurality of streaming images displayed before the missing streaming image; and
   displaying the streaming image on a display device and displaying, instead of the missing streaming image, the interpolated streaming image on the display device.

Furthermore, according to still another aspect, the present invention provides a game system including a client terminal and a server,
the client terminal including
   an acceptance unit that accepts a user input related to the progress of a running game,
   a transmission unit that transmits, to a server, input information indicating the content of the user input,
   a reception unit that receives, from the server, a streaming image indicating the result of the progress of the running game executed at the server in response to the input information,
   a detection unit that detects an event in which the streaming image is missing,
   a generation unit that estimates, from a plurality of streaming images related to the running game, the content of a streaming image to be displayed after the plurality of streaming images and that generates an interpolated streaming image indicating the result of the estimation of the content of the missing streaming image on the basis of an estimation model for generating a streaming image indicating the estimated content and the plurality of streaming images displayed before the missing streaming image, and
   a display control unit that displays the streaming image on a display device and that displays, instead of the missing streaming image, the interpolated streaming image on the display device, and
the server including
   an input information receiving unit that receives the input information from the client terminal,
   a game progressing unit that executes processing for progressing the running game on the basis of the input information and that generates the streaming image indicating the result of the progress of the running game, and
   an image transmitting unit that transmits the streaming image to the client terminal.

Furthermore, according to still another aspect, the present invention provides a processing method including:
in a client terminal of a game system that includes the client terminal and a server,
   accepting a user input related to the progress of a running game,
   transmitting, to the server, input information indicating the content of the user input,
   receiving, from the server, a streaming image indicating the result of the progress of the running game executed at the server in response to the input information,
   detecting an event in which the streaming image is missing,
   estimating, from a plurality of streaming images related to the running game, the content of a streaming image to be displayed after the plurality of streaming images, and generating an interpolated streaming image indicating the result of the estimation of the content of the missing streaming image on the basis of an estimation model for generating a streaming image indicating the estimated content and the plurality of streaming images displayed before the missing streaming image, and
   displaying the streaming image on a display device and displaying, instead of the missing streaming image, the interpolated streaming image on the display device; and
in the server,
   receiving the input information from the client terminal,
   executing processing for progressing the running game on the basis of the input information and generating the streaming image indicating the result of the progress of the running game, and
   transmitting the streaming image to the client terminal.

### Advantageous Effects of Invention

According to one aspect of the present invention, it is possible to solve the problem that a natural screen cannot be maintained when several frames are missing in image streaming.

### BRIEF DESCRIPTION OF DRAWINGS

The above-mentioned object, other objects, features, and advantages will be further apparent from a preferred embodiment to be described below and the following accompanying drawings.

FIG. 1 is a view showing an example functional block diagram of a game system.

FIG. 2 is a view showing an example hardware configuration of a client terminal and a server.

FIG. 3 is a view showing an example functional block diagram of the client terminal and the server.

FIG. 4 is a view for explaining interpolation processing executed by the client terminal.

FIG. 5 is a flowchart showing the flow of processing at the client terminal.

FIG. 6 is a view for explaining an Example of the game system.

### DESCRIPTION OF EMBODIMENTS

An embodiment of the present invention will be described below by using the drawings. Note that, in all of the drawings, identical reference signs are assigned to similar components, and a description thereof will be omitted as appropriate.

### Outline

In a game system of this embodiment, a client terminal is provided with a generative NN (Neural Network) model for interpolating an image. Then, this game system uses the generative NN model in the client terminal to interpolate an image missing in streaming in cloud gaming. Specifically, the client terminal buffers images of several frames received by streaming from the server. Then, the client terminal uses the NN model to infer two pieces of information, i.e., an optical flow and depth information, from these series of images, and generates an image for interpolating a missing image, by using the two inference results.

Accordingly, even if several frames are missing in image streaming due to network latency etc., the NN model in the client terminal interpolates the missing images, thereby making it possible to maintain a natural game screen.

A technical feature of the game system of this embodiment is that the client terminal does not have content-specific information, such as a 3D model or game-specific logic, but uses only content-independent logic, such as images that can be obtained from the server, to interpolate an image missing in streaming. An advantageous point of this embodiment is that interpolating a missing image can be realized by providing the NN model in a client terminal in cloud gaming, without making a big change to the architecture and the communication method of existing cloud gaming.

### Overall Configuration

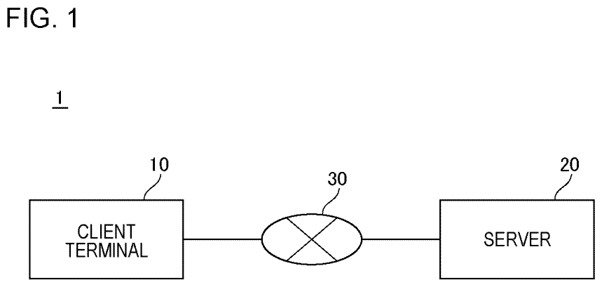

As shown in FIG. 1, a game system 1 has a client terminal 10 and a server 20. The client terminal 10 and the server 20 are connected so as to be able to communicate with each other via a communication network 30. The client terminal 10 is, for example, a smartphone, a tablet terminal, a personal computer, a game console, a mobile phone, a smart watch, or the like, but is not limited thereto. The server 20 is a cloud server, for example, but is not limited thereto.

### Hardware Configuration

First, an example hardware configuration of the client terminal 10 will be described. Individual functional units of the client terminal 10 are realized by any combination of hardware and software centered on a CPU (Central Processing Unit), a memory, a program loaded into the memory, a storage unit such as a hard disk that stores the program (that is also capable of storing a program downloaded from a recording medium, such as a CD (Compact Disc), and a server etc. on the Internet, in addition to a program stored in advance from the stage of shipping of the device), and an interface for network connection, of any computer. Then, it is understood by a person skilled in the art that there various modifications of the implementation method and the device can be made.

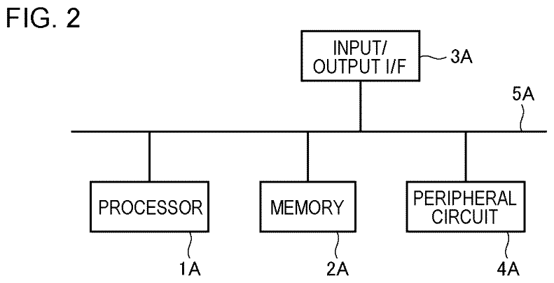

FIG. 2 is a block diagram illustrating the hardware configuration of the client terminal 10. As shown in FIG. 2, the client terminal 10 has a processor 1A, a memory 2A, an input/output interface 3A, a peripheral circuit 4A, and a bus 5A. The peripheral circuit 4A includes various modules. The client terminal 10 does not have to have the peripheral circuit 4A. Note that the client terminal 10 may be constituted of a plurality of physically and/or logically separated devices. In this case, each of the plurality of devices can include the above-described hardware configuration.

The bus 5A is a data transmission channel for the processor 1A, the memory 2A, the peripheral circuit 4A, and the input/output interface 3A to send and receive data to and from each other. The processor 1A is, for example, an arithmetic processing unit such as a CPU or a GPU. The memory 2A is, for example, a memory such as a RAM (Random Access Memory) or a ROM (Read Only Memory). The input/output interface 3A includes an interface for obtaining information from an input device, an external device, an external server, an external sensor, a camera, etc., and an interface for outputting information to an output device, the external device, the external server, etc. The input device is, for example, a keyboard, a mouse, a microphone, a physical button, a touchscreen, or the like. The output device is, for example, a display, a speaker, a printer, a mailer, or the like. The processor 1A can issue commands to the individual modules and perform calculations based on the calculation results of the modules.

Next, an example hardware configuration of the server 20 will be described. Individual functional units of the server 20 are realized by any combination of hardware and software centered on a CPU, a memory, a program loaded into the memory, a storage unit such as a hard disk that stores the program (that is also capable of storing a program downloaded from a recording medium, such as a CD, and a server etc. on the Internet, in addition to a program stored in advance from the stage of shipping of the device), and an interface for network connection, of any computer. Then, it is understood by a person skilled in the art that there are various modifications of the implementation method and the device.

FIG. 2 is a block diagram illustrating the hardware configuration of the server 20. As shown in FIG. 2, the server 20 has a processor 1A, a memory 2A, an input/output interface 3A, a peripheral circuit 4A, and a bus 5A. The functions of these constituents are as described above.

The client terminal 10 and the server 20 realize their functions suited for the respective purposes by installing programs for the respective purposes and by using parts having performances for the respective purposes.

### Functional Configuration

Next, a functional configuration of the game system 1 of this embodiment will be described in detail.

### <Client Terminal 10>

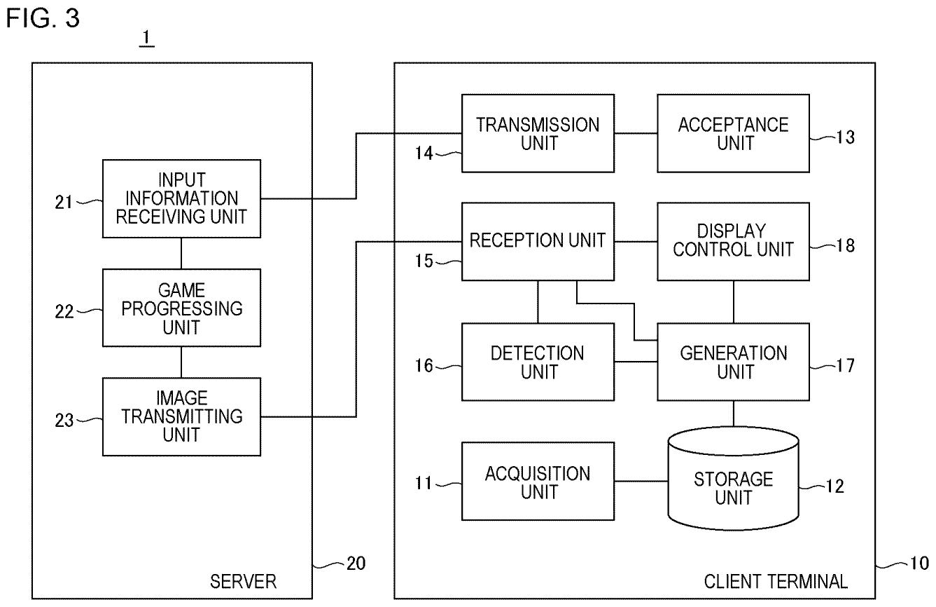

FIG. 3 shows an example functional block diagram of the client terminal 10. As shown in the figure, the client terminal 10 has an acquisition unit 11, a storage unit 12, an acceptance unit 13, a transmission unit 14, a reception unit 15, a detection unit 16, a generation unit 17, and a display control unit 18.

The acquisition unit 11 acquires an estimation model for interpolating a missing streaming image and stores the estimation model in the storage unit 12.

A “streaming image” is an image sent in streaming from the server 20 to the client terminal 10, in cloud gaming. In cloud gaming, an image showing the content of a running game (so-called “game screen”) is sent and received as a streaming image.

“Missing in streaming images” means that a streaming image is not received by the client terminal 10 by a predetermined timing. In this embodiment, it is assumed that, when the next streaming image does not arrive (cannot be received) within a predetermined period of time from a reference timing, the next streaming image is missing. The reference timing is the timing at which the previous streaming image is received or the timing equivalent thereto. The predetermined period of time is a predetermined value.

“Interpolating” means that a missing streaming image in a plurality of chronological streaming images is generated on the basis of the other streaming images.

An “estimation model” estimates, from a plurality of chronological streaming images, the content of a streaming image to be displayed after the plurality of chronological streaming images and generates a streaming image showing the estimated content (referred to as “interpolated streaming image”).

The estimation model generates an interpolated streaming image, by using a generative NN model, such as a GAN (Generative Adversarial Network), a VAE (Variational Auto-Encoder), NeRF (Neural Radiance Fields), IFNet, etc., on the basis of an optical flow and depth information estimated from a plurality of streaming images. A means for estimating an optical flow and depth information from a plurality of streaming images is not particularly limited, and any technology can be adopted. A widely known frame interpolation model, such as DAIN and RIFE, can be used as an estimation model.

Note that an estimation model is prepared for each game. Each estimation model is trained on images of each game. By preparing an estimation model for each game, an interpolated streaming image can be generated with higher accuracy.

The acquisition unit 11 acquires, from a provider server, any of a plurality of estimation models prepared so as to respectively correspond to a plurality of games, to be specific, an estimation model that corresponds to a game selected by a user, and stores the acquired estimation model in the storage unit 12. Specifically, in the storage unit 12 of each client terminal 10, an estimation model corresponding to a game selected by the user of the client terminal 10 is stored. The provider server may be different from or the same as the server 20, which is provided for each game and manages the progress of the game.

For example, when a desired game is selected from a predetermined website or application, and the application of the selected game is downloaded and installed into the client terminal 10, the estimation model corresponding to the selected game may be downloaded and installed into the client terminal 10. Specifically, the acquisition unit 11 may acquire the estimation model at this timing and store the estimation model in the storage unit 12.

Alternatively, every time a game of which the application has already been downloaded and installed into the client terminal 10 is executed, the corresponding estimation model may be downloaded and installed into the client terminal 10 at the timing of the start of execution (for example, at the timing at which the application is started, at the timing at which a predetermined operation is accepted after the application is started, or the like). Specifically, the acquisition unit 11 may acquire the estimation model at this timing and store the estimation model in the storage unit 12.

Note that the timings of acquiring an estimation model that have been illustrated here are merely examples, and the present invention is not limited thereto.

The acceptance unit 13 accepts user inputs related to the progress of a running game. The type of the game is not particularly limited. The acceptance unit 13 accepts the user inputs via any input device such as a touchscreen, a physical button, a keyboard, a mouse, a microphone, or a gesture input device.

The effects of user inputs on the progress of a game are defined for each game in advance. For example, with user inputs, a character moves in a predetermined direction, the line-of-sight direction of a character changes to a predetermined direction, a character attacks an enemy character, and a character defends.

The transmission unit 14 transmits, to the server 20, input information indicating the content of a user input accepted by the acceptance unit 13.

The reception unit 15 receives, from the server 20, a streaming image indicating the result of the progress of the running game executed by the server 20 according to the input information transmitted by the transmission unit 14.

The display control unit 18 displays the streaming image received by the reception unit 15 on a display device. The display device is a display, a projection device, or the like. The display control unit 18 displays the streaming image on the display device after executing predetermined processing such as decoding with respect to the data received by the reception unit 15.

Furthermore, the display control unit 18 buffers streaming images. For example, the display control unit 18 buffers (temporarily stores) streaming images of N frames at most. N is a value determined in advance on the basis of the number of streaming images required by the estimation model to generate an interpolated streaming image.

The detection unit 16 detects an event in which a streaming image is missing. In the case where the next streaming image does not arrive (the reception unit 15 does not receive the next streaming image) within a predetermined period of time from a reference timing, the detection unit 16 determines that the next streaming image is missing. The reference timing is the timing at which the previous streaming image is received or the timing equivalent thereto. The predetermined period of time is a predetermined value.

The generation unit 17 generates an interpolated streaming image indicating the estimation result of the content of a missing streaming image, on the basis of the estimation model stored in the storage unit 12 and corresponding to the running game and a plurality of streaming images displayed before the missing streaming image (a plurality of streaming images buffered by the display control unit 18 and related to the running game). Then, the display control unit 18 displays the interpolated streaming image generated by the generation unit 17 on the display device, instead of the missing streaming image.

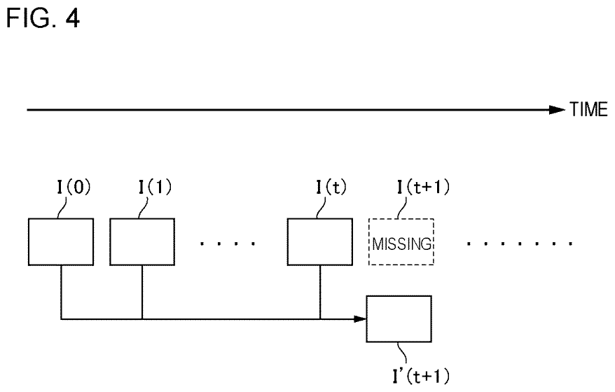

For example, as shown in FIG. 4, in the case where a streaming image I(t+1) at a time (t+1) is missing, the generation unit 17 generates an interpolated streaming image I′(t+1) on the basis of a plurality of streaming images I(0) to I(t) displayed before the streaming image I(t+1). Then, after displaying the streaming images I(0) to I(t) in this order, the display control unit 18 displays the interpolated streaming image I′(t+1), instead of the missing streaming image I(t+1). Note that the streaming image I(t) is a streaming image immediately before the streaming image I(t+1).

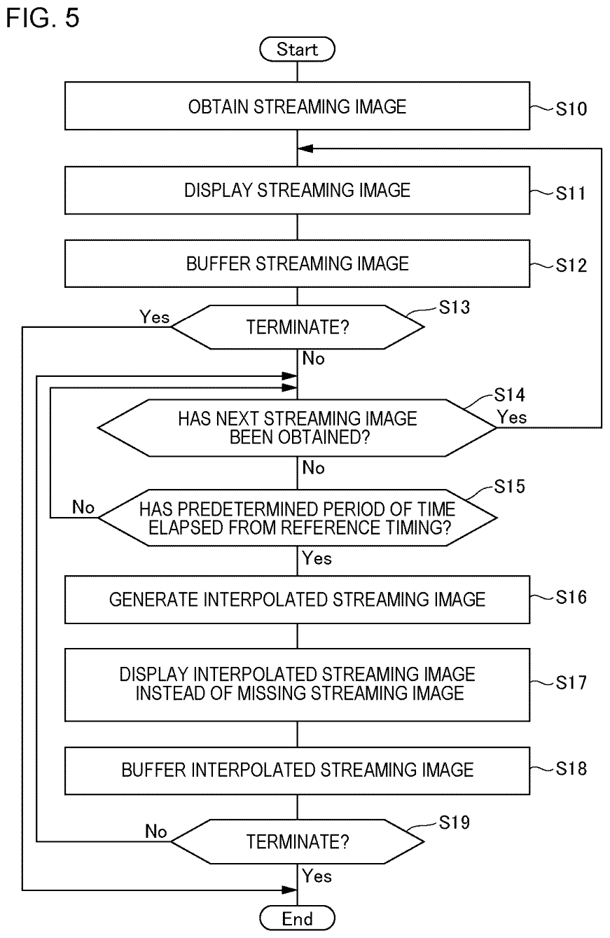

Next, an example of the flow of processing at the client terminal 10 will be described by using a flowchart shown in FIG. 5. FIG. 5 shows the flow of display control processing executed by the client terminal 10 after cloud gaming is started.

When a streaming image is obtained from the server 20 (S10), the client terminal 10 executes predetermined processing such as decoding and then displays the streaming image on the display device (S11). Then, the client terminal 10 buffers the streaming image (S12). If there is no input to terminate the processing (No in S13), the client terminal 10 waits for the next streaming image (S14).

While the next streaming image is not obtained (No in S14), the client terminal 10 monitors whether a predetermined period of time has elapsed from a reference timing (S15). The reference timing is the timing at which the previous streaming image is received or the timing equivalent thereto. The predetermined period of time is a predetermined value.

If the predetermined period of time has not elapsed from the reference timing (No in S15), the client terminal 10 continues to wait for the next streaming image (S14). Then, if the next streaming image is obtained before the predetermined period of time is elapsed from the reference timing (Yes in S14), the client terminal 10 executes predetermined processing such as decoding and then displays the streaming image on the display device (S11). Then, the client terminal 10 buffers the streaming image (S12).

On the other hand, if the predetermined period of time has elapsed from the reference timing before the next streaming image is obtained (Yes in S15), the client terminal 10 generates an interpolated streaming image to be used as a substitute for a missing streaming image (S16). Specifically, the client terminal 10 generates the interpolated streaming image on the basis of the above-described estimation model corresponding to the running game and a plurality of buffered streaming images.

Then, the client terminal 10 displays the interpolated streaming image generated in S16 on the display device instead of the missing streaming image (S17). Next, the client terminal 10 buffers the generated interpolated streaming image (S18). Note that it is also possible that the client terminal 10 buffers only received streaming images and does not buffer a generated interpolated streaming image.

Thereafter, the client terminal 10 repeats the same processing as that described above.

### <Server 20>

FIG. 3 shows an example functional block diagram of the server 20. As shown in the figure, the server 20 has an input information receiving unit 21, a game progressing unit 22, and an image transmitting unit 23.

The input information receiving unit 21 receives input information from the client terminal 10. The input information receiving unit 21 receives input information transmitted by the above-described transmission unit 14 of the client terminal 10.

The game progressing unit 22 executes processing for progressing the running game on the basis of the input information received by the input information receiving unit 21 and generates a streaming image indicating the result of the progress of the running game. The content of the game progress based on the input information is a design matter determined in advance for each game. For example, on the basis of input information, the game progressing unit 22 moves a character in a predetermined direction in a game space, changes the line-of-sight direction of the character to a predetermined direction, executes an attack on an enemy character by the character, and executes defense by the character. Then, the game progressing unit 22 generates new streaming images indicating the results of the game progress. Those processing procedures executed by the game progressing unit 22 are realized by using any of widely known technologies.

The image transmitting unit 23 transmits the streaming images generated by the game progressing unit 22 to the client terminal 10. The image transmitting unit 23 transmits the streaming images to the client terminal 10 in streaming.

### Example

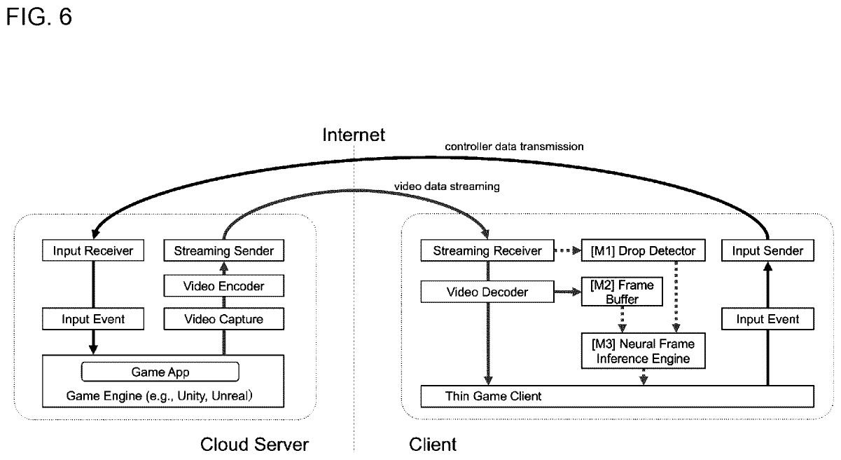

Next, an Example of this embodiment will be described. In this Example, a neural network model that generates, when a plurality of chronological streaming images I(0), I(1), I(2), . . . I(t) are given, a streaming image I(t+1) at time (t+1) can be modeled as a technology to be introduced into a client side in cloud gaming (FIG. 6).

The most important configuration of this Example is to monitor the status of streaming from a cloud side and to execute frame interpolation when the streaming is interrupted. This system is configured of the following three modules implemented in the client side shown in FIG. 6.

[M1] Drop Detector monitors the status of streaming reception of frame information (streaming image) rendered on the cloud side, and, if next frame information does not arrive during a predetermined period of time, starts [M3] Neural Frame Interference Engine to interpolate missing frame information. Furthermore, [M1] Drop Detector stores, in [M2] Frame Buffer, the frame information received from the cloud. The predetermined period of time is a design matter. For example, in a 30 fps game in which 30 streaming images are received per second, the latency of receiving one streaming image is about 0.033 seconds (33 milliseconds).

[M2] Frame Buffer is a fixed-length ring buffer and holds streaming images of N frames at most. This system infers depth information and an optical flow from these N streaming images and interpolates a missing streaming image. Specifically, the images stored in [M2] Frame Buffer correspond to the above-described plurality of chronological streaming images I(0), I(1), I(2), . . . I(t).

[M3] Neural Frame Interference Engine uses, as inputs, the plurality of chronological streaming images I(0), I(1), I(2), . . . I(t), which are stored in [M2] Frame Buffer, to generate a streaming image I(t+1) at time (t+1), by using a neural network model such as DAIN or RIFE, for example.

### Advantageous Effects

In the game system 1 of this embodiment, a generative NN model (estimation model) that generates the next streaming image from streaming images (game screens) that have been streamed so far is introduced into an edge side (client terminal 10 side) in cloud gaming, and, when missing in streaming images occurs, i.e., when the next streaming image does not arrive within a predetermined period of time, the missing streaming image is generated at the edge side. Accordingly, even if streaming images of several frames are missing due to network latency or the like, the estimation model at the edge side interpolates the missing streaming images, thereby making it possible to maintain a natural game screen.

A technical feature of the game system 1 of this embodiment is that the client terminal 10 does not have content-specific information, such as a 3D model or a game-specific logic, and uses only a content-independent logic, such as image information that can be obtained from the server 20, to interpolate a missing streaming image.

An advantageous point of the game system 1 of this embodiment is that interpolating a missing streaming image can be realized by downloading an estimation model corresponding to a game to be played in the client terminal 10 in cloud gaming, without making a big change to the architecture and the communication method of existing cloud gaming. When solving the problem of a missing streaming image, the game system 1 of this embodiment also solves the compatibility with existing cloud-gaming systems, which is a side problem thereof.

The game system 1 of this embodiment performs extremely versatile network-latency interpolation while utilizing the processor on the client terminal 10 side, without increasing the load on the server 20 side. Conventional network-latency interpolation technologies for games are often dependent on specific game genres and game contents, and it is difficult to realize versatile latency countermeasure technologies. The game system 1 of this embodiment is an excellent technology that focuses on the fact that the data structure used in cloud rendering is an extremely simple video stream, and that performs communication-latency interpolation by performing frame interpolation for the video stream.

### MODIFICATIONS

Next, modifications of this embodiment will be described. In the modifications, advantageous effects similar to those of this embodiment are realized.

### Modification 1

It is also possible that the server 20 intentionally omits to send streaming images of about several frames to the client terminal 10 at a predetermined timing. Even with this configuration, the missing streaming images are interpolated at the client terminal 10 side, so there is no problem. With this configuration, the load on the server 20 can be reduced.

For example, the server 20 may not send streaming images of about several frames every predetermined period of time. Alternatively, when a predetermined condition is satisfied, the server 20 may not send streaming images of about several frames every predetermined period of time. The predetermined condition is that the load on the server 20 is greater than a predetermined level, and, for example, is defined as “the number of client terminals 10 connected to the server 20 (the number of players playing games) is equal to or greater than a threshold” or the like.

### Modification 2

In this embodiment, which has been described above, in response to the fact that the detection unit 16 detects missing in streaming images, the generation unit 17 generates an interpolated streaming image for interpolating the missing streaming image. In a modification, the generation unit 17 may generate interpolated streaming images corresponding to all streaming images, irrespective of the fact that the detection unit 16 detects missing in streaming images. In the case of this modification, the generation unit 17 can generate interpolated streaming images at an earlier timing. Theoretically, the generation unit 17 can start processing for generating an interpolated streaming image I′(t+1) for interpolating a streaming image I(t+1) when the streaming images I(0), I(1), I(2), . . . I(t) are obtained.

In this modification, if missing in streaming images is not detected by the detection unit 16, the display control unit 18 displays, on the display device, streaming images received by the reception unit 15 from the server 20. Then, if missing in streaming images is detected by the detection unit 16, the display control unit 18 displays, on the display device, an interpolated streaming image generated by the generation unit 17.

### Modification 3

The technology of this embodiment can be used for, instead of cloud gaming, game distribution and streaming distribution of anime etc.

Although embodiments of the present invention have been described above with reference to the drawings, these embodiments are examples of the present invention, and various configurations other than those described above can also be adopted. The configurations of the above-described embodiments may be combined with each other, and some of the configurations may be replaced with other configurations. Furthermore, in the configurations of the above-described embodiments, various changes may be added without departing from the gist. Furthermore, the configurations and the processing procedures disclosed in the above-described embodiments and modifications may be combined with each other.

Furthermore, although a plurality of steps (processing procedures) are described in order in the flowchart used in the above explanation, the order of steps executed in each embodiment is not limited to the described order. In each embodiment, the order of steps shown in the figure can be changed as long as the change does not interfere with the content. Furthermore, the above-described embodiments can be combined as long as the contents thereof do not conflict.

Although a portion or the entirety of the above-described embodiments can be noted as in the following appendixes, the present invention is not limited thereto.

1. A program causing a computer in a client terminal to function as:
an acceptance unit that accepts a user input related to the progress of a running game;
a transmission unit that transmits, to a server, input information indicating the content of the user input;
a reception unit that receives, from the server, a streaming image indicating the result of the progress of the running game executed at the server in response to the input information;
a detection unit that detects an event in which the streaming image is missing;
a generation unit that estimates, from a plurality of streaming images related to the running game, the content of a streaming image to be displayed after the plurality of streaming images and that generates an interpolated streaming image indicating the result of the estimation of the content of the missing streaming image on the basis of an estimation model for generating a streaming image indicating the estimated content and the plurality of streaming images displayed before the missing streaming image; and
a display control unit that displays the streaming image on a display device and that displays, instead of the missing streaming image, the interpolated streaming image on the display device.

2. A program according to claim 1, causing the computer to further function as an acquisition unit that acquires the estimation model from a provider server.

3. A program according to claim 2, wherein the acquisition unit acquires, from the provider server, one of a plurality of estimation models prepared so as to respectively correspond to a plurality of games.

4. A program according to claim 3, wherein the acquisition unit acquires, from the provider server, the estimation model that corresponds to a game selected by a user input from among a plurality of games.

5. A program according to claim 1, wherein, in the case where the next streaming image does not arrive within a predetermined period of time from a reference timing, the detection unit determines that the streaming image is missing.

6. A program according to claim 1, wherein the estimation model generates the interpolated streaming image on the basis of an optical flow and depth information estimated from the plurality of streaming images.

7. A client terminal including:
an acceptance unit that accepts a user input related to the progress of a running game;
a transmission unit that transmits, to a server, input information indicating the content of the user input;
a reception unit that receives, from the server, a streaming image indicating the result of the progress of the running game executed at the server in response to the input information;
a detection unit that detects an event in which the streaming image is missing;
a generation unit that estimates, from a plurality of streaming images related to the running game, the content of a streaming image to be displayed after the plurality of streaming images and that generates an interpolated streaming image indicating the result of the estimation of the content of the missing streaming image on the basis of an estimation model for generating a streaming image indicating the estimated content and the plurality of streaming images displayed before the missing streaming image; and
a display control unit that displays the streaming image on a display device and that displays, instead of the missing streaming image, the interpolated streaming image on the display device.

8. A processing method including:
in a client terminal,
   accepting a user input related to the progress of a running game;
   transmitting, to a server, input information indicating the content of the user input;
   receiving, from the server, a streaming image indicating the result of the progress of the running game executed at the server in response to the input information;
   detecting an event in which the streaming image is missing;
   estimating, from a plurality of streaming images related to the running game, the content of a streaming image to be displayed after the plurality of streaming images, and generating an interpolated streaming image indicating the result of the estimation of the content of the missing streaming image on the basis of an estimation model for generating a streaming image indicating the estimated content and the plurality of streaming images displayed before the missing streaming image; and
   displaying the streaming image on a display device and displaying, instead of the missing streaming image, the interpolated streaming image on the display device.

9. A game system including a client terminal and a server,
the client terminal including
   an acceptance unit that accepts a user input related to the progress of a running game,
   a transmission unit that transmits, to a server, input information indicating the content of the user input,
   a reception unit that receives, from the server, a streaming image indicating the result of the progress of the running game executed at the server in response to the input information,
   a detection unit that detects an event in which the streaming image is missing,
   a generation unit that estimates, from a plurality of streaming images related to the running game, the content of a streaming image to be displayed after the plurality of streaming images and that generates an interpolated streaming image indicating the result of the estimation of the content of the missing streaming image on the basis of an estimation model for generating a streaming image indicating the estimated content and the plurality of streaming images displayed before the missing streaming image, and
   a display control unit that displays the streaming image on a display device and that displays, instead of the missing streaming image, the interpolated streaming image on the display device, and
the server including
   an input information receiving unit that receives the input information from the client terminal,
   a game progressing unit that executes processing for progressing the running game on the basis of the input information and that generates the streaming image indicating the result of the progress of the running game, and
   an image transmitting unit that transmits the streaming image to the client terminal.

10. A processing method including:
in a client terminal of a game system that includes the client terminal and a server,
   accepting a user input related to the progress of a running game,
   transmitting, to the server, input information indicating the content of the user input,
   receiving, from the server, a streaming image indicating the result of the progress of the running game executed at the server in response to the input information,
   detecting an event in which the streaming image is missing,
   estimating, from a plurality of streaming images related to the running game, the content of a streaming image to be displayed after the plurality of streaming images, and generating an interpolated streaming image indicating the result of the estimation of the content of the missing streaming image on the basis of an estimation model for generating a streaming image indicating the estimated content and the plurality of streaming images displayed before the missing streaming image, and
   displaying the streaming image on a display device and displaying, instead of the missing streaming image, the interpolated streaming image on the display device; and
in the server,
   receiving the input information from the client terminal,
   executing processing for progressing the running game on the basis of the input information and generating the streaming image indicating the result of the progress of the running game, and
   transmitting the streaming image to the client terminal.

This application claims priority based on Japanese Patent Application No. 2023-052653 filed on Mar. 29, 2023, the entire disclosure of which is incorporated herein.

### REFERENCE SIGNS LIST

1 game system
10 client terminal
11 acquisition unit
12 storage unit
13 acceptance unit
14 transmission unit
15 reception unit
16 detection unit
17 generation unit
18 display control unit
20 server
21 input information receiving unit
22 game progressing unit
23 image transmitting unit
30 communication network
1A processor
2A memory
3A input/output I/F
4A peripheral circuit
5A bus

What is claimed is:

1. A program causing a computer in a client terminal to function as:
an acceptance unit that accepts a user input related to the progress of a running game;
a transmission unit that transmits, to a server, input information indicating the content of the user input;
a reception unit that receives, from the server, a streaming image indicating the result of the progress of the running game executed at the server in response to the input information;
a detection unit that detects an event in which the streaming image is missing;
a generation unit that estimates, from a plurality of streaming images related to the running game, the content of a streaming image to be displayed after the plurality of streaming images and that generates an interpolated streaming image indicating the result of the estimation of the content of the missing streaming image on the basis of an estimation model for generating a streaming image indicating the estimated content and the plurality of streaming images displayed before the missing streaming image; and
a display control unit that displays the streaming image on a display device and that displays, instead of the missing streaming image, the interpolated streaming image on the display device.

2. A program according to claim 1, causing the computer to further function as an acquisition unit that acquires the estimation model from a provider server.

3. A program according to claim 2, wherein the acquisition unit acquires, from the provider server, one of a plurality of estimation models prepared so as to respectively correspond to a plurality of games.

4. A program according to claim 3, wherein the acquisition unit acquires, from the provider server, the estimation model that corresponds to a game selected by a user input from among a plurality of games.

5. A program according to claim 1, wherein, in the case where the next streaming image does not arrive within a predetermined period of time from a reference timing, the detection unit determines that the streaming image is missing.

6. A program according to claim 1, wherein the estimation model generates the interpolated streaming image on the basis of an optical flow and depth information estimated from the plurality of streaming images.

7. A client terminal comprising:
an acceptance unit that accepts a user input related to the progress of a running game;
a transmission unit that transmits, to a server, input information indicating the content of the user input;
a reception unit that receives, from the server, a streaming image indicating the result of the progress of the running game executed at the server in response to the input information;
a detection unit that detects an event in which the streaming image is missing;
a generation unit that estimates, from a plurality of streaming images related to the running game, the content of a streaming image to be displayed after the plurality of streaming images and that generates an interpolated streaming image indicating the result of the estimation of the content of the missing streaming image on the basis of an estimation model for generating a streaming image indicating the estimated content and the plurality of streaming images displayed before the missing streaming image; and
a display control unit that displays the streaming image on a display device and that displays, instead of the missing streaming image, the interpolated streaming image on the display device.

8. A processing method comprising:
in a client terminal,
accepting a user input related to the progress of a running game;
transmitting, to a server, input information indicating the content of the user input;
receiving, from the server, a streaming image indicating the result of the progress of the running game executed at the server in response to the input information;
detecting an event in which the streaming image is missing;
estimating, from a plurality of streaming images related to the running game, the content of a streaming image to be displayed after the plurality of streaming images, and generating an interpolated streaming image indicating the result of the estimation of the content of the missing streaming image on the basis of an estimation model for generating a streaming image indicating the estimated content and the plurality of streaming images displayed before the missing streaming image; and
displaying the streaming image on a display device and displaying, instead of the missing streaming image, the interpolated streaming image on the display device.

9. A game system comprising a client terminal and a server,
the client terminal comprising
an acceptance unit that accepts a user input related to the progress of a running game,
a transmission unit that transmits, to a server, input information indicating the content of the user input,
a reception unit that receives, from the server, a streaming image indicating the result of the progress of the running game executed at the server in response to the input information,
a detection unit that detects an event in which the streaming image is missing,
a generation unit that estimates, from a plurality of streaming images related to the running game, the content of a streaming image to be displayed after the plurality of streaming images and that generates an interpolated streaming image indicating the result of the estimation of the content of the missing streaming image on the basis of an estimation model for generating a streaming image indicating the estimated content and the plurality of streaming images displayed before the missing streaming image, and
a display control unit that displays the streaming image on a display device and that displays, instead of the missing streaming image, the interpolated streaming image on the display device, and
the server comprising
an input information receiving unit that receives the input information from the client terminal,
a game progressing unit that executes processing for progressing the running game on the basis of the input information and that generates the streaming image indicating the result of the progress of the running game, and
an image transmitting unit that transmits the streaming image to the client terminal.

10. A processing method comprising:
in a client terminal of a game system that includes the client terminal and a server,
accepting a user input related to the progress of a running game,
transmitting, to the server, input information indicating the content of the user input,
receiving, from the server, a streaming image indicating the result of the progress of the running game executed at the server in response to the input information,
detecting an event in which the streaming image is missing,
estimating, from a plurality of streaming images related to the running game, the content of a streaming image to be displayed after the plurality of streaming images, and generating an interpolated streaming image indicating the result of the estimation of the content of the missing streaming image on the basis of an estimation model for generating a streaming image indicating the estimated content and the plurality of streaming images displayed before the missing streaming image, and
displaying the streaming image on a display device and displaying, instead of the missing streaming image, the interpolated streaming image on the display device; and
in the server,
receiving the input information from the client terminal,
executing processing for progressing the running game on the basis of the input information and generating the streaming image indicating the result of the progress of the running game, and
transmitting the streaming image to the client terminal.
